(19) United States
(12) Patent Application Publication
(10) Pub. No.: US 2010/0104300 A1
(43) Pub. Date: Apr. 29, 2010

(54) IMAGE FORMING APPARATUS

(75) Inventor: Eiji SHINOHARA, Shizuoka (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/607,536

(22) Filed: Oct. 28, 2009

Related U.S. Application Data
(60) Provisional application No. 61/109,469, filed on Oct. 29, 2008.

(51) Int. Cl. G03G 15/00

(52) U.S. Cl. 399/43

(57) ABSTRACT

In case of printing of a monochrome image is performed and the number of counts of a K-counter reaches a predetermined number, a K developing device forcibly consumes a toner when a printing ratio is lower than a predetermined value, and does not forcibly consume the toner when the printing ratio is equal to or higher than the predetermined value. When the number of counts of the K counter reaches the predetermined number, necessary amounts of toners are supplied to developing devices for all colors for Y, M, C, and K according to detection results of auto toner sensors.

### CROSS-REFERENCE TO RELATED APPLICATION

This application is based upon and claims the benefit of priority from provisional U.S. Application 61/109,469 filed on Oct. 29, 2008, the entire contents of which are incorporated herein by reference.

### TECHNICAL FIELD

The present invention relates to an image forming apparatus such as a copying machine or a printer including a developing device that controls the supply of a developer.

### BACKGROUND

Among color image forming apparatuses such as a copying machine and a printer, there is an apparatus that applies toner refresh to all developing devices for Y (yellow), M (magenta), C (cyan), and K (black) when it is determined that the number of prints in a color mode exceeds a predetermined number and a printing ratio of an image is low. The toner refresh is operation for forcibly consuming an old toner in a developer container and supplying a new toner. A developer is deteriorated due to friction caused by agitation and carrying for a long time in a developer container. Acceleration of deterioration of the developer can be reduced by performing the toner refresh.

However, even in a color image forming apparatus, when a user continues to print monochrome images, the toner refresh for a developing device for K cannot be performed. Therefore, it is likely that deterioration in a K developer is accelerated. On the other hand, the color image forming apparatus performs image quality maintenance control or automatic alignment control at predetermined timing such as during warming-up. Therefore, in the color image forming apparatus, even when the user continues to print only monochrome images, Y, M, and C toners decrease. However, while the monochrome images are printed, developing devices for Y, M, and C are stopped and Y, M, and C toners are not supplied. Even when a color image is not printed, toner densities are lowered in the developing devices for Y, M, and C. Therefore, it is likely that an error in image quality maintenance or automatic alignment occurs.

It is desired to suppress deterioration in the K developer due to agitation and carrying and prevent the lowering in toner densities of the developing devices for Y, M, and C, when the user continues to print monochrome images in the color image forming apparatus.

### SUMMARY

An aspect of the present invention is to suppress deterioration in a K developer to obtain a satisfactory monochrome image and maintain toner densities of developing devices for Y, M, and C to prevent an error in image quality maintenance control or automatic alignment control, when a user continues to print monochrome images.

According to an embodiment, an image forming apparatus includes: plural image bearing members; a latent-image forming unit to form respective electrostatic latent images on the plural image bearing members; plural developing units to include at least a black developing unit and color developing units and supply developers to the plural image bearing members, respectively; a first detecting unit to detect a use characteristic of the black developing unit; plural supplying units to supply supplemental developers to the plural developing units, respectively; and an adjusting unit to adjust the developers of the plural developing units according to a detection result of the first detecting unit.

### DESCRIPTION OF THE DRAWINGS

FIG. 1 is an overall diagram of an image forming apparatus according to an embodiment;

FIG. 2 is a schematic structural diagram of a developing device according to the embodiment;

FIG. 3 is a block diagram of a control system for toner refresh for the developing device according to the embodiment; and

FIG. 4 is a flowchart of a process of the toner refresh for the developing device according to the embodiment.

### DETAILED DESCRIPTION

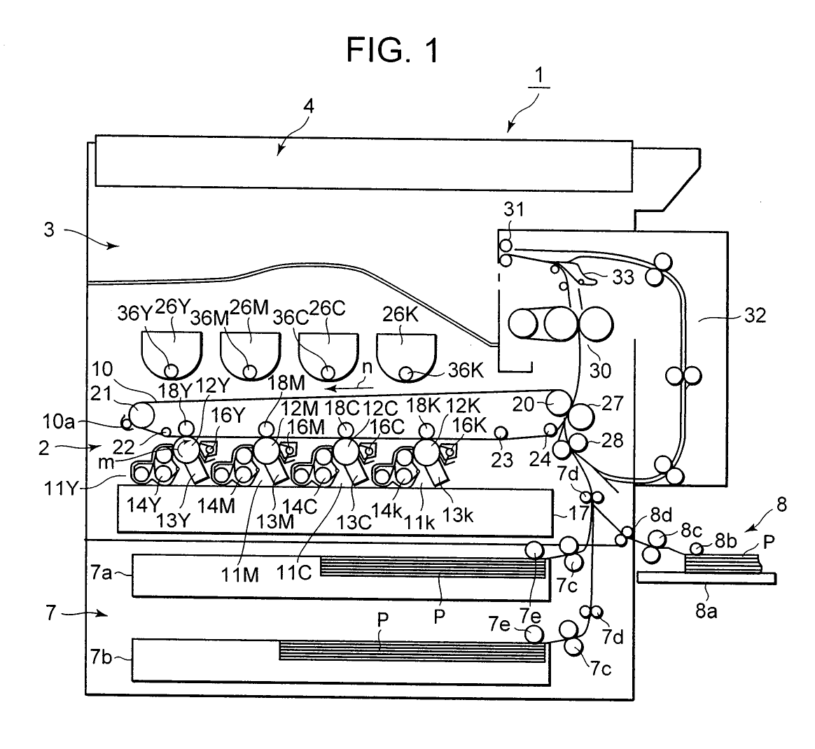

An embodiment is explained below. FIG. 1 is a schematic structural diagram of a color printer 1 as an image forming apparatus according to this embodiment. The color printer 1 includes a printer unit 2 that forms an image, a paper discharge unit 3 that stores sheets P discharged from the printer unit 2, a scanner unit 4 that reads a document image, and a paper feeding device 7 and a bypass paper feeding device 8 that feed the sheets P.

The printer unit 2 includes four sets of image forming stations 11Y, 11M, 11C, and 11K arranged in parallel along the lower side of an intermediate transfer belt 10. The image forming stations 11Y, 11M, 11C, and 11K respectively include photoconductive drums 12Y, 12M, 12C, and 12K as image bearing members. The image forming stations 11Y, 11M, 11C, and 11K respectively form toner images of Y (yellow), M (magenta), C (cyan), and K (black) on the photoconductive drums 12Y, 12M, 12C, and 12K.

The photoconductive drums 12Y, 12M, 12C, and 12K rotate in an arrow m direction. Electrifying chargers 13Y, 13M, 13C, and 13K, developing devices 14Y, 14M, 14C, and 14K as developing units, and photoconductive member cleaners 16Y, 16M, 160, and 16K are respectively arranged along a rotating direction around the photoconductive drums 12Y, 12M, 12C, and 12K.

In the respective image forming stations 11Y, 11M, 11C, and 11K, the photoconductive drums 12Y, 12M, 12C, and 12K, the electrifying chargers 13Y, 13M, 13C, and 13K, the developing devices 14Y, 14M, 14C, and 14K, and the photoconductive member cleaners 16Y, 16M, 16C, and 16K may be respectively integrated to configure process cartridges. When the process cartridges are formed, the process cartridges are integrally attached to and detached from a main body of the color printer 1 independently from one another.

Exposure lights by a laser exposing, device 17 are respectively irradiated between the electrifying chargers 13Y, 13M, 13C, and 13K and the developing devices 141, 14M, 14C, and 14K around the photoconductive drums 12Y, 12M, 12C, and 12K. The laser exposing device 17 scans laser beams emitted from semiconductor laser elements in axis directions of the photoconductive drums 12Y, 12M, 12C, and 12K. Electrostatic latent images are respectively formed on the photoconductive drums 12Y, 12M, 12C, and 12K by the irradiation of the exposure lights from the laser exposing device 17. The electrifying chargers 13Y, 13M, 13C, and 13K and the laser exposing device 17 configure a latent image forming unit.

The developing devices 14Y, 14M, 140, and 14K respectively supply toners to the electrostatic latent images on the photoconductive drums 12Y, 12M, 12C, and 12K and visualize the electrostatic latent images. The developing devices 14Y, 14M, and 14C as color developing units perform development respectively using two-component developers including the Y, M, and C toners and a carrier. The developing device 14K as a black developing unit performs development using a two-component developer including the K toner and the carrier.

Toner cartridges 26Y, 26M, 26C, and 26K which respectively store toners as supplementary developers of Y, M, C, and K supplied to the developing devices 14Y, 14M, 14C, and 14K are respectively arranged above the developing devices 14Y, 14M, 14C, and 14K. The toner cartridges 26Y, 26M, 26C, and 26K respectively include toner augers 36Y, 36M, 36C, and 36K which carry toners in the directions of the developing devices 14Y, 14M, 14C, and 14K. Toner supply amounts are obtained by detecting the numbers of rotations of the toner augers 36Y, 36M, 36C, and 36K.

The intermediate transfer belt 10 is stretched and suspended by a backup roller 20, a driven roller 21, and first to third tension rollers 22 to 24. The intermediate transfer belt 10 is rotated in an arrow n direction. The intermediate transfer belt 10 is opposed to and set in contact with the photoconductive drums 12Y, 12M, 12C, and 12K. Primary transfer rollers 18Y, 18M, 180, and 18K are respectively provided in positions of the intermediate transfer belt 10 opposed to the photoconductive drums 12Y, 12M, 12C, and 12K. The primary transfer rollers 18Y, 18M, 18C, and 18K respectively primarily transfer toner images formed on the photoconductive drums 12Y, 12M, 12C, and 12K onto the intermediate transfer belt 10. The photoconductive member cleaners 16Y, 16M, 16C, and 16K respectively remove and collect residual toners on the photoconductive drums 12Y, 12M, 12C, and 12K after the primary transfer.

A secondary transfer roller 27 is, opposed to a secondary transfer section supported by the backup roller 20 for the intermediate transfer belt 10. In the secondary transfer section, predetermined secondary transfer bias is applied to the backup roller 20. When the sheet P passes between the intermediate transfer belt 10 and the secondary transfer roller 27, the toner images on the intermediate transfer belt 10 are secondarily transferred onto the sheet P. The sheet P is fed from a paper feeding cassette 7a or 7b or a bypass paper feeding device 8. After the secondary transfer finished, the intermediate transfer belt 10 is cleaned by a belt cleaner 10a.

Pickup rollers 7e, separation rollers 7c, conveying rollers 7d, and a registration roller pair 28 are provided between the paper feeding device 7 and the secondary transfer roller 27. A manual feed pickup roller 8b, manual feed separation rollers 8c, and manual feed conveying rollers 8d are provided between a manual feed tray 8a of the bypass paper feeding device 8 and the registration roller pair 28. A fixing device 30 is provided downstream of the secondary transfer roller 27 along a conveying direction of the sheet P.

The fixing device 30 fixes the toner images, which are transferred onto the sheet P in the secondary transfer section, on the sheet P. A gate 33 that guides sheets to a paper discharge roller 31 direction or a re-conveying unit 32 direction is provided downstream of the fixing device 30. The sheet guided to the paper discharge roller 31 is discharged to a paper discharge unit 3. The sheet guided to the re-conveying unit 32 is guided in the secondary transfer roller 27 direction again.

In the color printer 1, when a print process is stared, after the electrifying chargers 13Y, 13M, 13C, and 13K respectively charge the photoconductive drums 12Y, 12M, 12C, and 12K, the laser exposing device 17 irradiates exposure lights on the photoconductive drums 12Y, 12M, 12C, and 12K, respectively, to form electrostatic latent ages corresponding to the exposure lights on the photoconductive drums 12Y, 12M, 12C, and 12K. The electrostatic latent images formed on the photoconductive drums 12Y, 12M, 12C, and 12K are respectively developed with the toners by the developing devices 14Y, 14M, 14C, and 14K and visualized. The toner images formed on the photoconductive drums 12Y, 12M, 12C, and 12K are transferred onto the sheet P by the secondary transfer roller 27 via the intermediate transfer belt 10.

After being fed from the paper feeding device 7 or the bypass paper feeding device 8, the sheet P reaches the secondary transfer position in synchronization with the toner images on the intermediate transfer belt 10. The toner images transferred on the sheet P are fixed by the fixing device 30. The sheet P on which the toner images are fixed is discharged to the paper discharge unit 3 through the paper discharge roller 31 or guided in the secondary transfer roller 27 side again through the re-conveying unit 32. When the color printer 1 ends the print process, the color printer 1 performs toner refresh for the developing devices 14Y, 14M, 14C, and 14K when necessary.

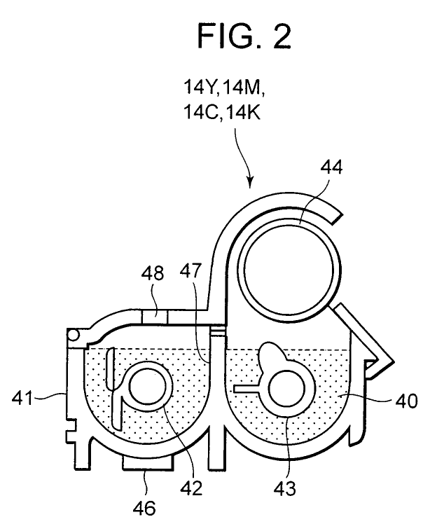

The developing devices 14Y, 14M, 14C, and 14K and the toner refresh for the developing devices 14Y, 14M, 14C, and 14K are explained below. Since the color developing devices 14Y, 14M, and 14C for Y, M, and C and the black developing device 14K for K have the same structure, the developing devices 14Y, 14M, 14C, and 14K are explained by using common reference numerals and signs and the color signs are omitted. As shown in FIG. 2, each of the developing devices 14Y, 14M, 14C, and 14K includes a case 41 which stores each of two-component developers 40Y, 40M, 40C, and 40K, first and second mixers 42 and 43, a developing roller 44, and an auto toner sensor (ATS) 46.

A toner supply port 48 is formed in an upper part of the case 41. The first mixer 42 and the second mixer 43 of the case 41 are partitioned by a partition plate 47. The first and second mixers 42 and 43 agitate and carry each of the developers 40Y, 40M, 40C, and 40K and feed the developer to the developing roller 44. The developing roller 44 feeds the toner to an electrostatic latent image on each of the photoconductive drums 12Y, 12M, 12C, and 12K and forms a toner image on each of the photoconductive drums 12Y, 12M, 12C, and 12K.

The auto toner sensor 46 is arranged on the bottom face of the case 41. As the auto toner sensor 46, for example, a magnetic permeability sensor is used. When a decrease in the toner density of each of the developers 40Y, 40M, 40C, and 40K in the case 41 is detected by the auto toner sensor 46, the toner is supplied, for example, from each of the toner cartridges 26Y, 26M, and 26C to the case 41 of each of the developing devices 14Y, 14M, 14C, and 14K according to a detection result of the auto toner sensor 46. Consequently, the toner density in the case 41 is maintained constant.

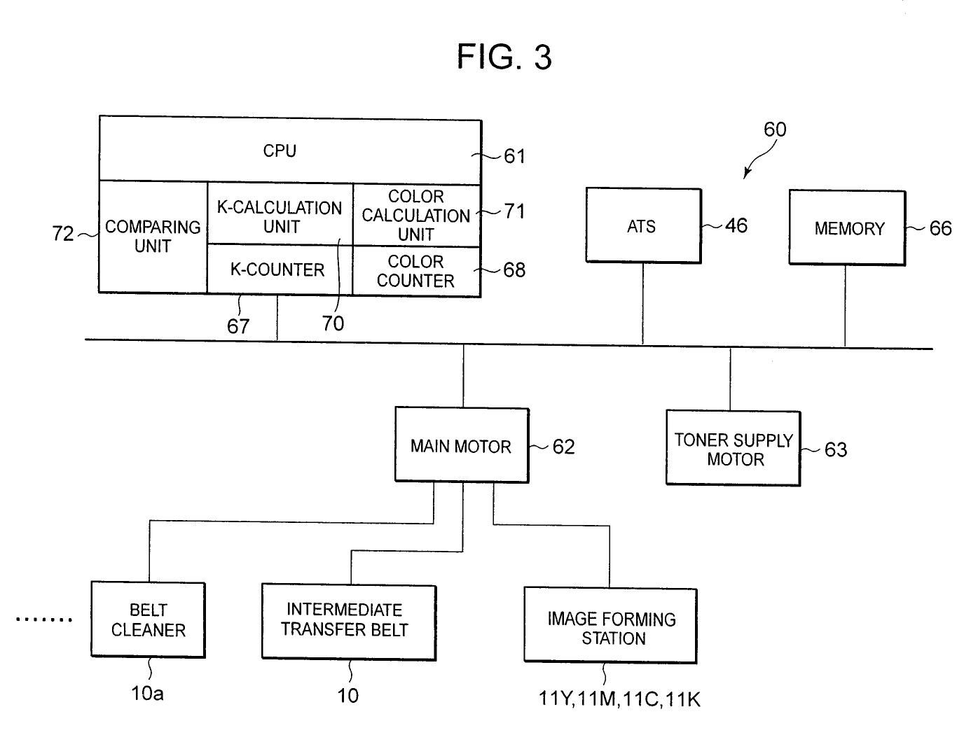

A block diagram of a control system 60 that mainly performs control of the toner refresh for the developing devices 14Y, 14M, 14C, and 14K is shown in FIG. 3. The auto toner sensor 46 and a memory 66 are connected to an input side of a CPU 61 which controls the entire color printer 1. The memory 66 stores a threshold of the number of prints that is a predetermined number as a determination reference for start of the toner refresh for the developing devices 14Y, 14M, 14C, and 14K and a threshold of a printing ratio that is a predetermined value of the printing ratio as a determination reference for execution of the toner refresh. The memory 66 stores, for example, 500 as the threshold of the number of prints and stores, for example, 4% as the threshold of the printing ratio.

The memory 66 stores a toner refresh pattern for forcibly consuming the toners in the developing devices 14Y, 14M, 14C, and 14K in the toner refresh. The size of the toner refresh pattern is common to all the colors. The toner refresh pattern is, for example, 90×297 mm per one color.

A main motor 62 and a toner supply motor 63 are connected to an output side of the CPU 61. The main motor 62 drives driving units for the image forming stations 11Y, 11M, 11C, and 11K and driving units for the intermediate transfer belt 10 and the belt cleaner 10a. The toner supply motor 63 drives the toner augers 36Y, 36M, 36C, and 36K.

The CPU 61 includes a K-counter 67 as a first counter that counts the number of prints of monochrome images and a color counter 68 as a second counter that counts the number of prints of a color image. The CPU 61 includes a K-calculation unit 70 as a first arithmetic operation unit that calculates a printing ratio of a monochrome image and a color calculation unit 71 as a second arithmetic operation unit that calculates a printing ratio of a color image.

The printing ratio is calculated from the number of prints counted by the K-counter 67 or the color counter 68 and a toner consumption amount, i.e., the number of rotations of each of the toner augers 36Y, 36M, 36C, and 36K. The printing ratio is defined as a printing ratio between from clear the K-counter 67 or the color counter 68 to the number of prints reaches the threshold “500”. The color calculation unit 71 calculates a printing ratio of each of the colors Y, M, and C. The K-counter 67 and the K-calculation unit 70 configure a first detecting unit. The color counter 68 and the color calculation unit 71 configure a second detecting unit.

The CPU 61 includes a comparing unit 72. The comparing unit 72 compares a count result of the K-counter 67 or a count result of the color counter 68 with the threshold of the number of prints stored in the memory 66. The comparing unit 72 compares an arithmetic operation result of the K-calculation unit 70 or an arithmetic operation result of the color calculation unit 71 with the threshold of the printing ratio stored in the memory 66.

According to a comparison result of the comparing unit 72, the image forming stations 11Y, 11M, 11C, and 11K respectively form electrostatic latent images corresponding to the refresh pattern stored in the memory 66 on the photoconductive drums 12Y, 12M, 12C, and 12K. The developing devices 14Y, 14M, 140, and 14K develop the electrostatic latent images on the photoconductive drums 12Y, 12M, 12C, and 12K and forcibly consume the toners.

The toner cartridges 26Y, 26M, 26C, and 26K supply predetermined amounts of the toners according to detection results of the auto toner sensors 46. The image forming stations 11Y, 11M, 11C, and 11K, the memory 66, the laser exposing device 17, the toner cartridges 26Y, 26M, 26C, and 26K, and the auto toner sensor 46 configure an adjusting unit.

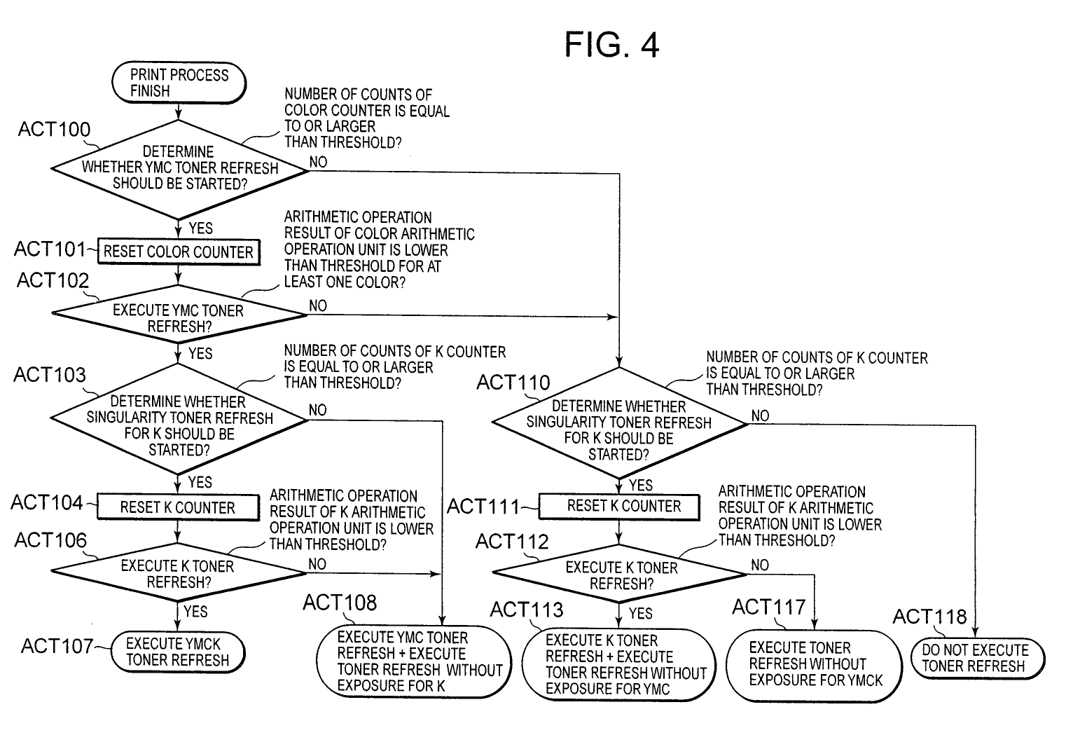

A process of toner refresh which forcibly consuming toners and supplying necessary amounts of new toners to adjust developers is explained with reference to a flowchart shown in FIG. 4. In this process, the toner refresh is defined as an operation for forcibly consuming old toners in the developing devices 14Y, 14M, 14C, and 14K and supplying new toners from the toner cartridges 26Y, 26M, 26C, and 26K according to detections result of the ATSs 46. In this process, toner refresh without exposure is defined as an operation for supplying new toners to the developing devices 14Y, 14M, 14C, and 14K without forcibly consuming toners according to detection results of the ATSs 46.

While the color printer 1 performs the print process, the K-counter 67 and the color counter 68 respectively count the numbers of image-forming times. When the color printer 1 finishes the print process, the color printer 1 goes to a ready state and stands by for the next print process. While the color printer 1 stands by for the next print process, the color printer 1 performs a toner refresh process. In ACT 100, the color printer 1 determines whether YMC toner refresh should be started. In ACT 100, the color printer 1 compares the number of counts of the color counter 68 with the threshold “500” stored in the memory 66. When the number of counts of the color counter 68 is equal to or larger than 500, the color printer 1 resets the color counter 68 in ACT 101 and proceeds to ACT 102.

In ACT 102, the color printer 1 determines whether the YMC toner refresh should be executed. In ACT 102, the color printer 1 compares the arithmetic operation result of the color calculation unit 71 with the threshold 4% of the printing ratio stored in the memory 66. According to the arithmetic operation result of the color calculation unit 71, when a printing ratio of at least one of Y, M, and C is lower than 4%, the color printer 1 proceeds to ACT 103. In ACT 103, the color printer 1 determines whether singularity toner refresh for the K toner should be started. In ACT 103, the color printer 1 compares the number of counts of the K-counter 67 with the threshold “500” stored in the memory 66. When the number of counts of the K-counter 67 is equal to or larger than 500, the color printer 1 resets the K-counter 67 in ACT 104 and proceeds to ACT 106. In ACT 106, the color printer 1 determines whether the singularity toner refresh for the K toner should be executed. In ACT 106, the color printer 1 compares the arithmetic operation result of the K-calculation unit 70 with the threshold 4% of the printing ratio stored in the memory 66. According to the arithmetic operation result of the K-calculation unit 70, when the printing ratio of a monochrome image is lower than 4%, the color printer 1 proceeds to ACT 107.

In ACT 107, the color printer 1 performs YMCK toner refresh for forcibly consuming the toners in the developing devices 14Y, 14M, 14C, and 14K for all the colors Y, M, C, and K, and supplying necessary amounts of new toners, respectively. In ACT 107, the color printer 1 forms toner images of the 90×297 mm toner refresh pattern stored in the memory 66 on the photoconductive drums 12Y, 12M, 12C, and 12K for all the colors. The formed toner images are primarily transferred onto, and removed from the intermediate transfer belt 10 by the belt cleaner 10a.

According to ACT 107, the toner which amount is corresponding to the 90×297 mm toner refresh pattern is forcibly consumed respectively in the developing devices 14Y, 14M, 14C, and 14K. Necessary amounts of the toners are respectively supplied from the toner cartridges 26Y, 26M, 26C, and 26K for Y, M, C, and K to the developing devices 14Y, 14M, 14C, and 14K according to detection results of the auto toner sensors 46. According to ACT 107, a part of the toners are replaced with new toners and proper toner densities are obtained in all the developing devices 14Y, 14M, 14C, and 14K.

When the number of counts of the K-counter 67 is smaller than 500 in ACT 103, the color printer 1 proceeds to ACT 108. When the printing ratio of the monochrome image is equal to or higher than 4%, according to the arithmetic operation result of the K-calculation unit 70 in ACT 106, the color printer 1 proceeds to ACT 108.

In ACT 108, the color printer 1 performs the YMC toner refresh in the color developing devices 14Y, 14M, and 14C for Y, M, and C and performs the toner refresh without exposure in the K-developing device 14K. In ACT 108, the color printer 1 forcibly consumes the toners in the color developing devices 14Y, 14M, and 14C for Y, M, and C and, on the other hand, supplies necessary amounts of new toners to all the developing devices 14Y, 14M, 14C, and 14K. In ACT 108, the color printer 1 forms toner images of the 90×297 mm toner refresh pattern stored in the memory 66 on the color photoconductive drums 12Y, 12M, and 12C for Y, M, and C. The formed toner images are primarily transferred onto, and removed from the intermediate transfer belt 10 by the belt cleaner 10a.

According to ACT 108, the toners of the color developing devices 14Y, 14M, and 14C for Y, M, and C are forcibly consumed. Necessary amounts of the toners are respectively supplied from the toner cartridges 26Y, 26M, 26C, and 26K to the developing devices 14Y, 14M, 14C, and 14K according to detection results of the auto toner sensors 46. According to ACT 108, a part of the toners are replaced with new toners and appropriate toner densities are obtained in all the developing devices 14Y, 14M, 14C, and 14K.

When the number of counts of the color counter 68 is smaller than 500 in ACT 100, the color printer 1 proceeds to ACT 110. When all the printing ratios of the color images are equal to or higher than 4% according to the arithmetic operation result of the color calculation unit 71 in ACT 102, the color printer 1 proceeds to ACT 110. In ACT 110, the color printer 1 determines whether the singularity toner refresh for only the K toner should be started. When the number of counts of the K-counter 67 is equal to or larger than 500 in ACT 110, the color printer 1 resets the K-counter 67 in ACT 111, and proceeds to ACT 112. In ACT 112, the color printer 1 determines whether the singularity toner refresh for the K toner should be started. According to the arithmetic operation result of the K-calculation unit 70 when the printing ratio of the monochrome image is smaller than 4% in ACT 112, the color printer 1 proceeds to ACT 113.

In ACT 113, the color printer 1 performs the K toner refresh for forcibly consuming the toner only for the developing device 14K for K and supplying a necessary amount of a new toner and performs the toner refresh without exposure in the color developing devices 14Y, 14M, and 14C for Y, M, and C. In ACT 113, the color printer 1 forms a toner image of the 90×297 mm toner refresh pattern only on the photoconductive drum 12K for K. The formed toner images are primarily transferred onto, and removed from the intermediate transfer belt 10 by the belt cleaner 10a.

According to ACT 113, the toner of only the developing device 14K is forcibly consumed. According to a detection result of the auto toner sensor 46, a necessary amount of the toner is supplied only from the toner cartridge 26K to the developing device 14K for K.

According to ACT 113, a part of the toner is replaced with a new toner only in the developing device 14K for K and appropriate toner densities are obtained in all the developing devices 14Y, 14M, 14C, and 14K.

When the number of counts of the K-counter 67 is smaller than 500 in ACT 100, the color printer 1 proceeds to ACT 118. In ACT 118, the color printer 1 does not perform the toner refresh. In ACT 118, the color printer 1 does not perform forcible consumption of the toners and does not perform toner supply either, in all the developing devices 14Y, 14M, 14C, and 14K for Y, M, C, and K.

When the printing ratio of the monochrome image is equal to or higher than 4%, according to the arithmetic operation result of the K-calculation unit 70 in ACT 112, the color printer 1 proceeds to ACT 117. In ACT 117, the color printer 1 performs the toner refresh without exposure in all the developing devices 14Y, 14M, 140, and 14K for Y, M, C, and K. In ACT 117, the color printer 1 does not perform forcible consumption of the toners in all the developing devices 14Y, 14M, 14C, and 14K for Y, M, C, and K, and performs supply of necessary amounts of new toners to all the developing devices 14Y, 14M, 14C, and 14K for Y, M, C, and K. According to ACT 117, appropriate toner densities are obtained in all the developing devices 14Y, 14M, 14C, and 14K.

Specifically, after the finish of the print process, (1) when both the numbers of prints of the color image and the monochrome image are equal to or larger than 500 and both the printing ratios of the color image and the monochrome image are lower than 4%, the color printer 1 performs the YMCK toner refresh according to ACT 107. The color printer 1 forcibly consumes the toners and supplies necessary amounts of new toners in all the developing devices 14Y, 14M, 14C, and 14K.

(2) When the number of prints of the color image is equal to or larger than 500, the printing ratio of the color image is lower than 4% and the number of prints of the monochrome image is smaller than 500, according to ACT 108, the color printer 1 performs the YMC toner refresh and performs the toner refresh without exposure in the developing device 14 for K. The color printer 1 forcibly consumes the toners in the color developing devices 14Y, 14M, and 14C for Y, M, and C and supplies necessary amounts of new toners to all the developing devices 14Y, 14M, 14C, and 4K for Y, M, C, and K.

(3) When both the numbers of prints of the color image and the monochrome image are equal to or larger than 500, the printing ratio of the color image is lower than 4% and the printing ratio of the monochrome image is equal to or higher than 4%, according to ACT 108, the color printer 1 performs the YMC toner refresh and performs the toner refresh without exposure in the developing device 14K for K.

(4) When the number of prints of the color image is smaller than 500, the number of prints of the monochrome image is equal to or larger than 500, and the printing ratio of the monochrome image is lower than 4%, according to ACT 113, the color printer 1 performs the K toner refresh and performs the toner refresh without exposure in the color developing devices 14Y, 14M, and 14C for Y, M, and C. The color printer 1 forcibly consumes the toner in the developing device 14K for K and supplies necessary amounts of new toners to all the developing devices 14Y, 14M, 14C, and 14K for Y, M, C, and K.

(5) When both the numbers of prints of the color image and the monochrome image are equal to or larger than 500, the printing ratio of the color image is equal to or higher than 4%, and the printing ratio of the monochrome image is lower than 4%, according to ACT 113, the color printer 1 performs the K toner refresh and performs the toner refresh without exposure in the color developing devices 14Y, 14M, and 14C for Y, M, and C.

(6) When the number of prints of the color image is smaller than 500, the number of prints of the monochrome image is equal to or larger than 500, and the printing ratio of the monochrome image is equal to or higher than 4%, according to ACT 117, the color printer 1 performs the toner refresh without exposure in all the developing devices 14Y, 14M, 14C, and 14K for Y, M, C, and K. The color printer 1 does not perform forcible consumption of the toners in all the developing devices 14Y, 14M, 14C, and 14K and supplies necessary amounts of new toners to all the developing devices 14Y, 14M, 14C, and 14K for Y, M, C, and K.

(7) When both the numbers of prints of the color image and the monochrome image are equal to or larger than 500 and both the printing ratios of the color image and the monochrome image are equal to or higher than 4%, according to ACT 117, the color printer 1 performs the toner refresh without exposure in all the developing devices 14Y, 14M, 14C, and 14K for Y, M, C, and K.

(8) When both the numbers of prints of the color image and the monochrome image are smaller than 500, the color printer 1 does not perform the toner refresh (ACT 118).

(9) When the number of prints of the color image is equal to or larger than 500, the printing ratio of the color image is equal to or higher than 4% and the number of prints of the monochrome image is smaller than 500, the color printer 1 does not perform the toner refresh (ACT 118).

The color printer 1 executes any one of ACT 107, ACT 108, ACT 113, ACT 117, and ACT 118 during the ready state and stands by for the next print instruction.

In this embodiment, the K-counter 67 and the color counter 68 respectively count the numbers of prints of the monochrome image and the color image. The K-calculation unit 70 and the color calculation unit 71 respectively calculate printing ratios of the monochrome image and the color image. According to the numbers of counts of the K-counter 67 or the color counter 68, and arithmetic operation results of the K-calculation unit 70 or the color calculation unit 71, the color printer 1 performs adjustment of the developers of the developing devices 14Y, 14M, 14C, and 14K. Even when the user continues to print monochrome images in the color printer 1, the toner refresh for the developing device 14K for K can be executed and deterioration in the developer due to agitation and carrying in the developing device 14K for K can be suppressed. Even when the user continues to print monochrome images in the color printer 1, the toners can be supplied to the color developing devices 14Y, 14M, and 14C for Y, M, and C. Toner densities of the color developing device 14Y, 14M, and 14C can be satisfactorily maintained, although lowering the toner of the color developing device 14Y, 14M, and 14C by image quality maintenance control, automatic alignment control, or the like of the color printer 1.

The present invention is not limited to the embodiment and can be variously changed without departing from the spirit of the present invention. For example, the predetermined number of prints as the determination reference for the start of the toner refresh is not limited. The predetermined value of a printing ratio as the determination reference for the execution of the toner refresh is not limited. The size and the shape of the toner refresh pattern for forcibly consuming the toners of the developing units are not limited. The image forming apparatus is not limited to the printer and may be a multifunction peripheral, a facsimile, and the like. As the configuration of the image forming apparatus, toner images formed on the image bearing members may be directly transferred onto a sheet. Toner refresh patterns formed on the image bearing members may be fixed after being transferred onto a sheet.

What is claimed is:

1. An image forming apparatus comprising:
plural image bearing members;
a latent-image forming unit to form respective electrostatic latent images on the plural image bearing members;
plural developing units to include at least a black developing unit and color developing units and supply developers to the plural image bearing members, respectively;
a first detecting unit to detect a use characteristic of the black developing unit;
plural supplying units to supply supplemental developers to the plural developing units, respectively; and
an adjusting unit to adjust the developers of the plural developing units according to a detection result of the first detecting unit.

2. The apparatus according to claim 1, wherein the adjusting unit includes a forced consumption mode for forcibly consuming the developers of the plural developing units and a supply mode for supplying the supplementary developers to the plural developing units.

3. The apparatus according to claim 2, wherein the first detecting unit includes a first counter to count a number of monochrome-image-forming times of the image bearing members.

4. The apparatus according to claim 3, wherein, when the number of monochrome-image-forming times counted by the first counter reaches a predetermined number, the adjusting unit supplies the supplementary developers to the black developing unit and the color developing unit, respectively.

5. The apparatus according to claim 3, wherein the first detecting unit includes a first calculating unit to calculate a black printing ratio of a monochrome image on the image bearing member.

6. The apparatus according to claim 5, wherein, when the number of monochrome-image-forming times counted by the first counter reaches a predetermined number and the black printing ratio calculated by the first calculating unit does not reaches a predetermined value, the adjusting unit forcibly consumes the developer of the black developing unit and supplies the supplementary developers to the black developing unit and the color developing units, respectively.

7. The apparatus according to claim 5, wherein, when the number of monochrome-image-forming times counted by the first counter reaches a predetermined number and the black printing ratio calculated by the first calculating unit is equal to or higher than a predetermined value, the adjusting unit supplies the supplementary developers to the black developing unit and the color developing units, respectively.

8. The apparatus according to claim 5, further comprising a second detecting unit to detect a use characteristic of the color developing units.

9. The apparatus according to claim 8, wherein the second detecting unit includes a second counter to count a number of color-image-forming times of the image bearing members, and a second calculating unit to calculate a color printing ratio of a color image on the image bearing members.

10. The apparatus according to claim 9, wherein when the number of color-image-forming times counted by the second counter reaches a predetermined value and the color printing ratio does not reach a predetermined value, and when the black printing ratio calculated by the first calculating unit does not reach a predetermined value, the adjusting unit forcibly consumes the developers of the black developing unit and the color developing units, respectively, and supplies the supplementary developers to the black developing unit and the color developing units, respectively, and
when the number of color-image-forming times counted by the second counter reaches the predetermined value and the color printing ratio does not reach the predetermined value and when the black printing ratio calculated by the first calculating unit is equal to or higher than the predetermined value, the adjusting unit forcibly consumes the developer of the color developing units and supplies the supplementary developers to the black developing unit and the color developing units, respectively.

11. The apparatus according to claim 1, further comprising a second detecting unit to detect a use characteristic of the color developing units.

12. A developer adjusting method for an image forming apparatus comprising:
detecting a use characteristic of a black developing unit while a color image or a monochrome image is formed; and
adjusting developers of the black developing unit and a color developing units, according to the use characteristic of the black developing unit.

13. The method according to claim 12, wherein detecting the use characteristic of the black developing unit according to count a number of monochrome-image-forming times.

14. The method according to claim 13, further comprising supplying developers to the black developing unit and the color developing units, respectively, when the number of monochrome-image-forming times reaches a predetermined number.

15. The method according to claim 13, wherein detecting the use characteristic of the black developing unit according to calculate a black printing ratio of the monochrome image.

16. The method according to claim 14, further comprising consuming the developer of the black developing unit forcibly and supplying the supplementary developers to the black developing unit and the color developing units, respectively, when the number of monochrome-image-forming times reaches a predetermined number and the black printing ratio does not reach a predetermined value.

17. The method according to claim 14, further comprising supplying the supplementary developers to the black developing unit and the color developing units, respectively when the number of monochrome-image-forming times reaches a predetermined number and the black printing ratio is equal to or higher than a predetermined value.

18. The method according to claim 14, wherein detecting a use characteristic of the color developing units, while the color image or the monochrome image is formed.

19. The method according to claim 13, wherein detecting the use characteristic of the color developing units, according to counting the number of color image and calculating a color printing ratio of the color image.

20. The method according to claim 19, further Comprising consuming the developers of the black developing unit and the color developing unit forcibly and supplying the supplementary developers to the black developing unit and the color developing unit, respectively, when the number of formed color image reaches a predetermined value and the color printing ratio of the color image does not reach a predetermined value, and when a black printing ratio of the monochrome image does not reach a predetermined value, and
consuming the developer of the color developing units forcibly and supplying the supplementary developers to the black developing unit and the color developing units, respectively, when the number of formed color image reaches the predetermined value and the color printing ratio of the color image does not reach the predetermined value, and when the black printing ratio of the monochrome image is equal to or higher than the predetermined value.
